(19) United States
(12) Patent Application Publication
(10) Pub. No.: US 2016/0377537 A1
(43) Pub. Date: Dec. 29, 2016

(54) FLUID DETECTOR AND COUPLER THEREOF

(71) Applicant: NATIONAL SUN YAT-SEN UNIVERSITY, Kaohsiung City (TW)

(72) Inventors: Jau-Sheng WANG, Kaohsiung City (TW); Steve LAO, Kaohsiung City (TW); Chang-Wei HO, Kaohsiung City (TW); Jia-Ching CHEN, Kaohsiung City (TW); Tai-De LIU, Kaohsiung City (TW)

(21) Appl. No.: 14/752,285

(22) Filed: Jun. 26, 2015

(51) Int. Cl. G01N 21/41

(52) U.S. Cl. CPC G01N 21/4133; G01N 2201/0846

(57) ABSTRACT

A fluid detector includes a coupler. The coupler includes a hollow tube, an optical fiber, and a jacket. A fluid delivery device includes a fluid output end and a fluid recovery end. The fluid output end is connected to a first input end of the hollow tube. The fluid recovery end is connected to a first output end of the hollow tube. An optical signal generator inputs an optical signal to a second input end of the optical fiber. A detection module includes an optical sensor, a database, and a processor. The optical sensor detects the optical signal outputted by the second output end and generates a sensing datum. The processor is electrically connected to the optical sensor and the database. The processor compares a characteristic value of the sensing datum with characteristic values of sample data stored in the database and generates a detection data.

### BACKGROUND OF THE INVENTION

1. Field of the Invention

The present invention relates to a fluid detector and a coupler thereof and, more particularly, to a fluid detector using an optical coupler to proceed with fluid detection.

2. Description of the Related Art

Fluid detection has various applications including drug residue, sewage identification, blood sugar concentration, etc. In the various applications, there is a wide variety of inspection items of fluid, such as the type, concentration, temperature, magnetic field change of the fluid, etc.

Generally, a fluid detector of a certain type cannot be applied in inspecting items of several types, such that the inspector must operate various fluid detectors of different types to complete hundreds of inspection items, which is laborsome to the inspector and highlights the poor detection efficiency of the conventional fluid detector encountering excessive inspection items.

In addition to the design of the equipment, the fluid detection accuracy depends on the environmental control. Among many environmental factors, interference of magnetic waves is most influential but most difficult to be isolated and most easily neglected. If the detection procedure cannot be carried out in an environment isolated from magnetic waves, the fluid detection accuracy of specific fluid inspection items will decrease.

Thus, a need exists for a fluid detector and a coupler thereof to improve the detection efficiency of the fluid detector while increasing the fluid detection accuracy.

### SUMMARY OF THE INVENTION

An objective of the present invention is to provide a fluid detector and a coupler thereof, wherein the fluid detector and the coupler can be applied to different inspection items to increase the detection efficiency.

Another objective of the present invention is to provide a fluid detector and a coupler thereof, wherein the fluid detector and the coupler can be isolated from magnetic waves during the inspection procedure to increase the detection efficiency.

The present invention fulfills the above objectives by providing a fluid detector including a coupler. The coupler includes a hollow tube, an optical fiber, and a jacket. The hollow tube includes a first input end and a first output end. A hollow passage is defined between the first input end and the first output end. The optical fiber includes a second input end and a second output end. A solid passage is defined between the second input end and the second output end. The hollow tube and the optical fiber are enveloped in the jacket. A side of an outer periphery of the hollow tube intimately abuts a side of an outer periphery of the optical fiber. A fluid delivery device includes a fluid output end and a fluid recovery end. The fluid output end is connected to the first input end of the hollow tube. The fluid recovery end is connected to the first output end of the hollow tube. An optical signal generator is connected to the second input end of the optical fiber. The optical signal generator is adapted to input an optical signal to the second input end of the optical fiber. A detection module includes an optical sensor, a database, and a processor. The optical sensor is connected to the second output end of the optical fiber. The optical sensor detects the optical signal outputted by the second output end and generates a sensing datum. The database is adapted to store a plurality of sample data. The processor is electrically connected to the optical sensor and the database. The processor is adapted to compare a characteristic value of the sensing datum with characteristic values of the plurality of sample data and is adapted to generate a detection data.

The sensing datum and the plurality of sample data can include wavelength spectrum data containing energy change in a particular wavelength range.

Each of the characteristic value of the sensing datum and the characteristic values of the plurality of sample data can be a coupling wavelength having lowest energy in the particular wavelength range.

The fluid delivery device can include a pump and a tank. The tank is adapted to store a fluid to be detected. The pump includes a first end forming the fluid output end and a second end connected to a first end of the tank. The pump is adapted to pump the fluid stored in the tank. A second end of the tank forms the fluid recovery end.

The hollow tube, the optical fiber, and the jacket can be made of a same material.

The coupler can further include an auxiliary hollow tube. The auxiliary hollow tube includes a first auxiliary input end and a first auxiliary output end. An auxiliary hollow passage is formed between the first auxiliary input end and the first auxiliary output end. The auxiliary hollow tube, the hollow tube, and the optical fiber are enveloped in the jacket. A side of an outer periphery of the auxiliary hollow tube intimately abuts another side of the outer periphery of the optical fiber.

The fluid delivery device can further include an auxiliary fluid output end and an auxiliary fluid recovery end. The auxiliary fluid output end is connected to the first auxiliary input end of the auxiliary hollow tube. The auxiliary fluid recovery end is connected to the first auxiliary output end of the auxiliary hollow tube.

The coupler can further include an auxiliary optical fiber. The auxiliary optical fiber includes a second auxiliary input end and a second auxiliary output end. An auxiliary solid passage is formed between the second auxiliary input end and the second auxiliary output end. The auxiliary optical fiber, the hollow tube, and the optical fiber are enveloped in the jacket. A side of an outer periphery of the auxiliary optical fiber intimately abuts another side of the outer periphery of the hollow tube.

The optical signal generator is connected to the second auxiliary input end of the auxiliary optical fiber. The optical signal generator is adapted to input an auxiliary optical signal towards the second auxiliary input end. The optical sensor is connected to the second auxiliary output end of the auxiliary optical fiber. The optical sensor is adapted to sense the auxiliary optical signal outputted by the second auxiliary output end and is adapted to generate an auxiliary sensing datum.

In an example of the coupler including the hollow tube and the optical fiber, the hollow tube can have a radius different from a radius of the optical fiber.

In another example of the coupler including the hollow tube, the optical fiber, and the auxiliary hollow tube, the hollow tube can have a radius different from a radius of the optical fiber, and the auxiliary hollow tube can have a radius different from the radius of the optical fiber. Furthermore, the radius of the auxiliary hollow tube can be different from the radius of the hollow tube.

In a further example of the coupler including the hollow tube, the optical fiber, and the auxiliary topical fiber, the optical fiber can have a radius different from a radius of the hollow tube, and the auxiliary optical fiber can have a radius different from the radius of the hollow tube. Furthermore, the radius of the auxiliary optical fiber can be different from the radius of the optical fiber.

In an example, the hollow tube and the optical fiber mutually abut with each other by a first coupling section length. The auxiliary hollow tube and the optical fiber mutually abut with each other by a second coupling section length. The first and second coupling section lengths are different from each other.

In another example, the hollow tube and the optical fiber mutually abut with each other by a first coupling section length. The hollow tube and the auxiliary optical fiber mutually abut with each other by a third coupling section length. The first and third coupling section lengths are different from each other.

In a further example, the hollow tube and the optical fiber mutually abut with each other by a first coupling section length. The auxiliary hollow tube and the optical fiber mutually abut with each other by a second coupling section length. The hollow tube and the auxiliary optical fiber mutually abut with each other by a third coupling section length. The auxiliary hollow tube and the auxiliary optical fiber mutually abut with each other by a fourth coupling section length. The first, second, third, and fourth coupling section lengths being different from one another.

In an example, the hollow tube has a hollow tube refractive index change. The auxiliary hollow tube has an auxiliary hollow tube refractive index change. The optical fiber has an optical fiber refractive index change. A first difference exists between the hollow tube refractive index change and the optical fiber refractive index change. A second difference exists between the auxiliary hollow tube refractive index change and the optical fiber refractive index change. The first and second differences are different from each other.

In another example, the hollow tube has a hollow tube refractive index change. The optical fiber has an optical fiber refractive index change. The auxiliary optical fiber has an auxiliary optical fiber refractive index change. A first difference exists between the hollow tube refractive index change and the optical fiber refractive index change. A third difference exists between the hollow tube refractive index change and the auxiliary optical fiber refractive index change. The first and third differences are different from each other.

In a further example, the hollow tube has a hollow tube refractive index change. The optical fiber has an optical fiber refractive index change. The auxiliary hollow tube has an auxiliary hollow tube refractive index change. The auxiliary optical fiber has an auxiliary optical fiber refractive index change. A first difference exists between the hollow tube refractive index change and the optical fiber refractive index change. A second difference exists between the auxiliary hollow tube refractive index change and the optical fiber refractive index change. A third difference exists between the hollow tube refractive index change and the auxiliary optical fiber refractive index change. A fourth difference exists between the auxiliary hollow tube refractive index change and the auxiliary optical fiber refractive index change and with the first, second, third, and fourth differences being different from one another.

In another aspect according to the present invention, a coupler includes a hollow tube having a first input end and a first output end. A hollow passage is defined between the first input end and the first output end. An optical fiber includes a second input end and a second output end. A solid passage is defined between the second input end and the second output end. The hollow tube and the optical fiber are enveloped in a jacket. A side of an outer periphery of the hollow tube intimately abuts a side of an outer periphery of the optical fiber.

The fluid detector and the coupler thereof according to the present invention are applicable to different inspection items, and the influence of external magnetic waves during the detection procedure can be isolated, increasing the detection efficiency and increasing the detection accuracy.

The present invention will become clearer in light of the following detailed description of illustrative embodiments of this invention described in connection with the drawings.

### BRIEF DESCRIPTION OF THE DRAWINGS

FIG. 1 is a diagrammatic view of a fluid detector according to the present invention.

FIG. 2 is a cross sectional view of a coupler of the fluid detector according to the present invention.

FIG. 3 is a diagram showing energy-wavelength curves of fluids of different concentrations detected by the fluid detector according to the present invention.

FIGS. 4a, 4b, 4c, and 4d are diagrams showing energy-wavelength curves of fluids at different temperatures detected by the fluid detector according to the present invention.

FIG. 5 is a diagrammatic view of a fluid detector of another embodiment according to the present invention.

FIGS. 6a, 6b, and 6c illustrate cross sectional views of different examples of a coupler of the fluid detector according to the present invention.

FIG. 7 is a partial, perspective view illustrating the coupler having a hollow tube and an optical fiber with a radius different from a radius of the hollow tube.

FIG. 8 is a diagram illustrating normalized power-wavelength curves under different separations between the axis of the hollow tube and the axis of the optical fiber.

FIG. 9 is a diagram illustrating the separation-wavelength curve of the coupler according to the present invention.

FIG. 10a is a cross sectional view of a coupler including a hollow tube, an optical fiber, and an auxiliary hollow tube according to the present invention, with the hollow tube, the optical fiber, and the auxiliary hollow tube having different radiuses.

FIG. 10b is a cross sectional view of a coupler including a hollow tube, an optical fiber, and an auxiliary optical fiber according to the present invention, with the hollow tube, the optical fiber, and the auxiliary optical fiber having different radiuses.

FIG. 11 is a diagrammatic view illustrating mutual abutting of the hollow tube and the optical fiber of the coupler according to the present invention.

FIG. 12 is a diagram illustrating the relationship between the coupling section length and the fill width at half maximum of the coupling wavelength of the coupler according to the present invention.

FIG. 13 is a diagram illustrating the change in the refractive indexes of the hollow tube and the optical fiber according to the present invention under the optical signal of different wavelengths.

FIG. 14 is a diagram illustrating the relationship between the angle and the fill width at half maximum of the coupling wavelength of the coupler according to the present invention.

### DETAILED DESCRIPTION OF THE INVENTION

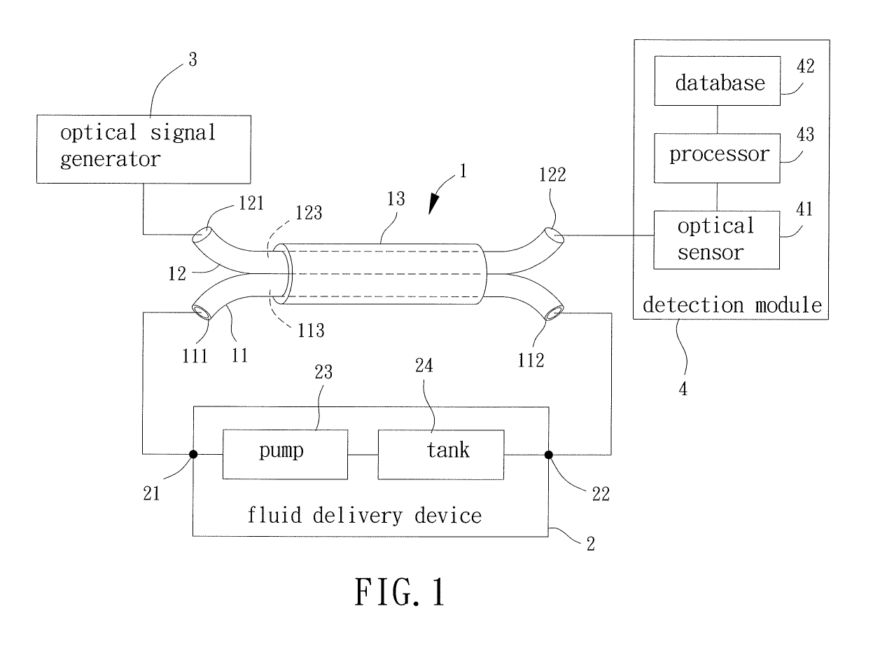

With reference to FIG. 1, a fluid detector according to the present invention includes a coupler 1, a fluid delivery device 2, an optical signal generator 3, and a detection module 4. The coupler 1 and the fluid delivery device 2 form a fluid guiding loop. An end of the coupler 1 is connected to the optical signal generator 3. The other end of the coupler 1 is connected to the detection module 4.

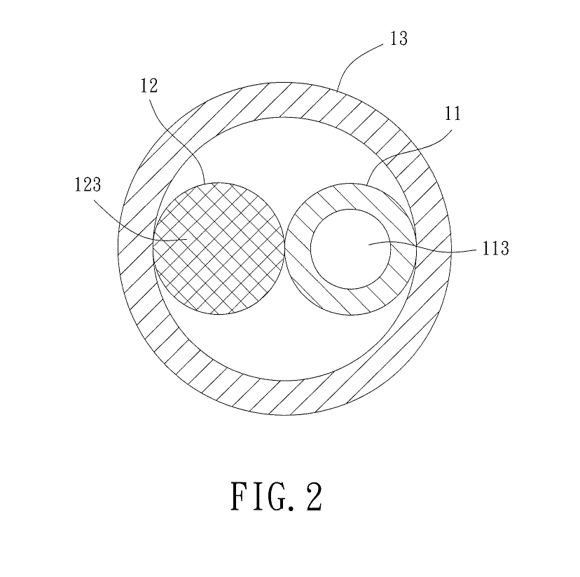

With reference to FIGS. 1 and 2, the coupler 1 includes a hollow tube 11, an optical fiber 12, and a jacket 13. The hollow tube 11 includes a first input end 111 and a first output end 112. A hollow passage 113 is defined between the first input end 111 and the first output end 112. The optical fiber 12 includes a second input end 121 and a second output end 122. A solid passage 123 is defined between the second input end 121 and the second output end 122. The hollow tube 11 and the optical fiber 12 are enveloped in the jacket 13. A side of an outer periphery of the hollow tube 11 intimately abuts a side of an outer periphery of the optical fiber 12. Namely, a portion of the outer periphery of the hollow tube 11 intimately abuts a portion of the outer periphery of the optical fiber 12.

Specifically, an optical fiber has a coupling effect during transmission of an optical signal, and a change in the refractive index and the energy occurs when the wavelength of the optical signal is different. Thus, the coupler 1 is comprised of the hollow tube 11, the optical fiber 12, and the jacket 13 in the present invention, such that when the coupler 1 undergoes simultaneous transmission of a fluid and an optical signal, the change of the refractive index and the energy of the optical signal of the coupler 1 is sensed to accomplish the fluid detection operation. The term “coupling effect” referred to herein is the effect generated during transmission of an optical signal in an optical fiber, which can be appreciated by a person having ordinary skill in the art. The maximum coupling efficiency is briefly described hereinafter. According to the coupling theory, the maximum coupling efficiency can be expressed as follows:

$$F = \frac{1}{1 + {( {β}_{d} / k )}^{2}} \qquad ( 1 )$$

wherein F is the maximum coupling efficiency, β_{d} is a propagation constant difference, and k is a coupling coefficient (the coupling coefficient between two optical fibers). β_{d} can be expressed as follows:

$${β}_{d} = \frac{{β}_{1} - {β}_{2}}{2} \qquad ( 2 )$$

wherein β₁ is the propagation constant of a first optical fiber in a particular mode, and β₂ is the propagation constant of a second optical fiber in a particular mode.

In this embodiment, the optical fiber 12 is a single mode fiber or a multi-mode fiber. The hollow tube 11 and the optical fiber 12 can be made from conventional materials for optical fiber cores. Furthermore, the hollow tube 11 and the optical fiber 12 can be made of the same material. For example, the material for both of the hollow tube 11 and the optical fiber 12 is silicon dioxide (quartz) or silicon dioxide doped with germanium or other element for increasing the refractive index. Furthermore, both of the hollow tube 11 and the optical fiber 12 can be made of polymethyl methacrylate (PMMA) or fluoropolymers. A side of the outer periphery of the hollow tube 11 intimately abuts a side of the outer periphery of the optical core 12. Thus, when a fluid to be detected flows through the hollow passage 113 and when an optical signal transmits through the solid passage 123, the fluid detection operation can be proceeded according to the change in the energy of the different wavelengths of the optical signal in the solid passage 123.

The material of the jacket 13 can be decided according to the material of the hollow tube 11 and the optical fiber 12. Preferably, the material of the jacket 13 is the same as the material of the hollow tube 11 and the optical fiber 12. For example, the material of the jacket 13 is silicon dioxide when the material of both of the hollow tube 11 and the optical fiber 12 is silicon dioxide (quartz). Thus, the transmission stability of the optical signal in the optical fiber 12 can be increased after the jacket 13 envelopes the hollow tube 11 and the optical fiber 12. Furthermore, since the coupler 1 is comprised of the optical core and the quartz jacket, due to the material characteristics of the coupler 1, the influence of external magnetic waves on the optical signal in the solid passage 123 can be reduced while the coupler 1 proceeds with the fluid detection operation, increasing the fluid detection accuracy.

The fluid delivery device 2 includes a fluid output end 21 and a fluid recovery end 22. The fluid output end 21 is connected to the first input end 111 of the hollow tube 11. The fluid recovery end 22 is connected to the first output end 112 of the hollow tube 11.

The fluid delivery device 2 can further include a pump 23 and a tank 24. The tank 24 stores the fluid to be detected. The pump 23 includes a first end forming the fluid output end 21 and a second end connected to a first end of the tank 24. A second end of the tank 24 forms the fluid recovery end 22. The pump 23 is adapted to pump the fluid stored in the tank 24. The fluid to be detected is transmitted through the fluid output end 21 to the first input end 111 of the hollow tube 11. Then, the fluid to be detected flows into the hollow passage 113 and is outputted through the first output end 112. Next, the fluid returns into the tank 24 via the fluid recovery end 22. Thus, the coupler 1 and the fluid delivery device 2 form the fluid guiding loop.

The fluid to be detected can be a flowable gas or a flowable liquid, such as toluene containing ethanol. However, the present invention is not limited in this regard. Furthermore, the pump 23 and the tank 24 are not limited to the type shown. Preferably, the pump 23 and the tank 24 can be selected according to the type of the fluid. For example, the pump can be a pump for delivering liquids or gases, and the tank 24 can be a liquid tank or a pneumatic cylinder, which can be appreciated by a person having ordinary skill in the art.

The optical signal generator 3 is connected to the second input end 121 of the optical fiber 12. The optical signal generator 3 is adapted to input an optical signal to the second input end 121 of the optical fiber 12.

Specifically, the optical signal generator 3 is used to input the optical signal with a particular wavelength range to the second input end 121 to transmit the optical signal through the solid passage 123 to the second output end 122. In this embodiment, the particular wavelength range of the optical signal generated by the optical signal generator 3 is 1200 nm-1700 nm. Furthermore, the maximum absorption power of the optical signal after coupling by the coupler 1 is 15 nW.

The detection module 4 includes an optical sensor 41, a database 42, and a processor 43. The optical sensor 41 is connected to the second output end 122 of the optical fiber 12. The optical sensor 41 detects the optical signal outputted by the second output end 122 and generates a sensing datum. The database 42 is used to store a plurality of sample data. The processor 43 is electrically connected to the optical sensor 41 and the database 42. The processor 43 is adapted to compare a characteristic value of the sensing datum with characteristic values of the sample data and is adapted to generate a detection datum.

The optical sensor 41 is a sensor for sensing the refractive index or the optical intensity. After the optical signal generator 3 inputs the optical signal into the solid passage 123, the optical sensor 41 detects the optical signal passing through the second output end 122 and generates the sensing datum according to the detection result. In this embodiment, the sensing datum is a wavelength spectrum datum containing energy change in a particular wavelength range. Furthermore, the sensing datum includes the characteristic value which is the value of the coupling wavelength having the lowest energy in the particular wavelength range.

The sample data stored in the database 42 include the wavelength spectrum data of to-be-detected fluids of different types or different characteristics. The wavelength spectrum data also include energy change in the particular wavelength range. The sample data also include characteristic values one of which is of the coupling wavelength having the lowest energy in the particular wavelength range. The creation of the sample data can be implemented by the coupler 1, the fluid delivery device 2, the optical signal generator 3, and the optical sensor 41 of this embodiment and can be obtained by the above operation procedure. Furthermore, the sample data preferably record the detection characteristics, such as the respective characteristic values, the fluid types, and temperatures, so as to be used in subsequent operation, such as data identification or output of the detection result.

The processor 43 can read the sensing datum generated by the optical sensor 41 and can compare the characteristic value of the sensing datum with the characteristic values of the sample data stored in the database 42 to find out the characteristic value of one of the sample data closest to the characteristic value of the sensing datum. In this embodiment, the characteristic values compared by the processor 43 are the coupling wavelength of the sensing datum having the lowest energy in the particular wavelength range and the coupling wavelengths of the sample data having the lowest energy in the particular wavelength range. After the sample datum having the closest characteristic value has been found, inspection characteristics, such as the type or the temperature of the fluid, recorded by the sample datum can be read and used as the detection data.

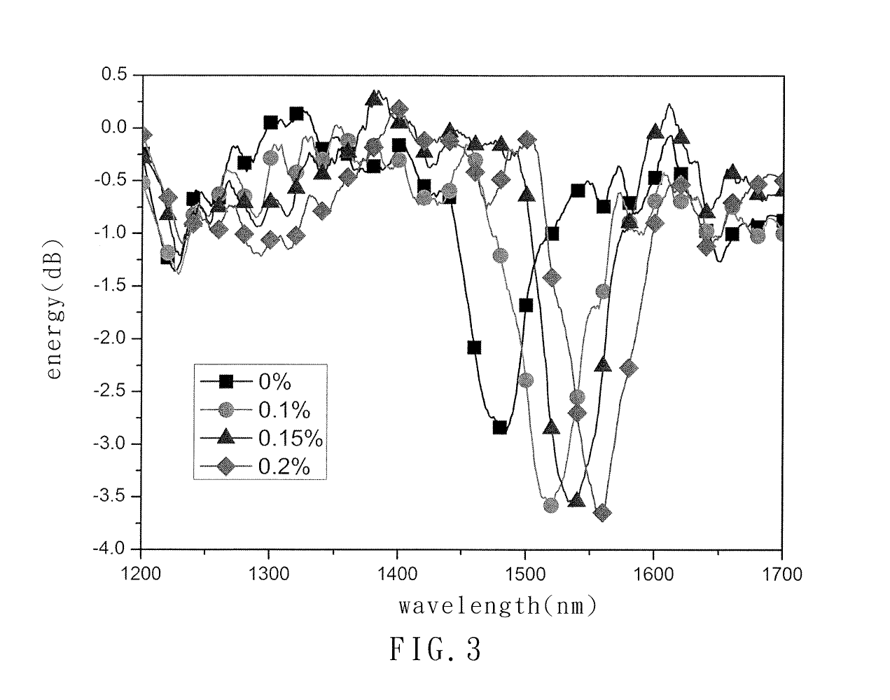

FIG. 3 is a diagram showing energy-wavelength curves of fluids of different concentrations detected by the fluid detector according to the present invention used to detect toluene. The abscissa is the wavelength (the unit is nm), and the ordinate is the absorption (namely, the amount of energy of the optical signal coupled to the hollow tube 11 by the optical fiber 12, the unit is dB). As can be seen from FIG. 3, toluene solutions respectively containing 0 wt %, 0.1 wt %, 0.15 wt %, and 0.2 wt % of ethanol have different wavelength spectrum data and have different coupling effects in the particular wavelength range of 1200 nm-1700 nm. Namely, when the toluene solutions contain different weight percentages of ethanol, the coupling wavelengths having the lowest energies are different (respectively about 1475 nm, 1520 nm, 1540 nm, and 1560 nm). Thus, the fluid detector according to the present invention can be used to detect the weight percentage of an ingredient in the fluid. Particularly, the above operations can be used to detect fluids of different ingredients or different concentrations to obtain several wavelength spectrum data, and the wavelength spectrum data can be stored in the database 42 as the sample data, permitting application of the fluid detector according to the present invention in detection of fluids of different ingredients or different concentrations to increase the detection efficiency.

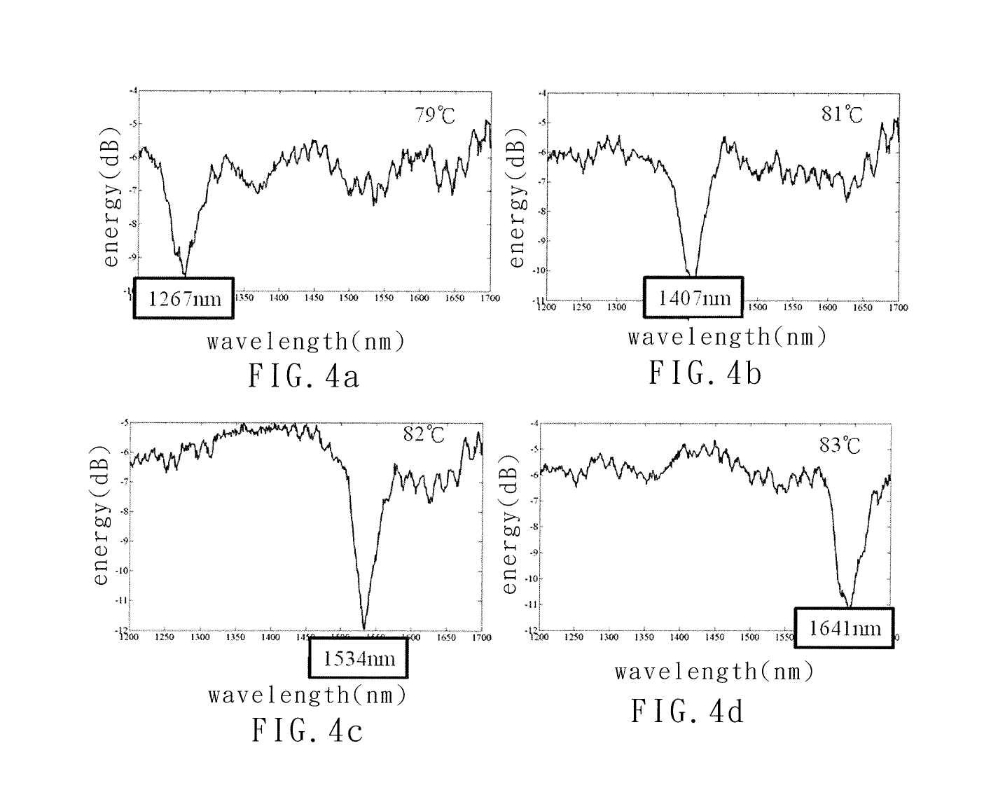

FIGS. 4a, 4b, 4c, and 4d are diagrams showing energy-wavelength curves of fluids at different temperatures detected by the fluid detector according to the present invention. The abscissa is the wavelength (the unit is nm), and the ordinate is the absorption (the unit is dB). As can be seen from FIGS. 4a-4d, toluene solutions respectively at 79° C., 81° C., 82° C., and 83° C. have different wavelength spectrum data and have different coupling effects in the particular wavelength range of 1200 nm-1700 nm. Namely, when the toluene solutions are at different temperatures, the wavelengths having the lowest energies are different (respectively about 1267 nm, 1407 nm, 1534 nm, and 1641 nm). Thus, the fluid detector according to the present invention can be used to detect the temperature of the fluid. Particularly, the above operations can be used to detect fluids at different temperatures to obtain several wavelength spectrum data, and the wavelength spectrum data can be stored in the database 42 as the sample data, permitting application of the fluid detector according to the present invention in detection of fluids at different temperatures to increase the detection efficiency.

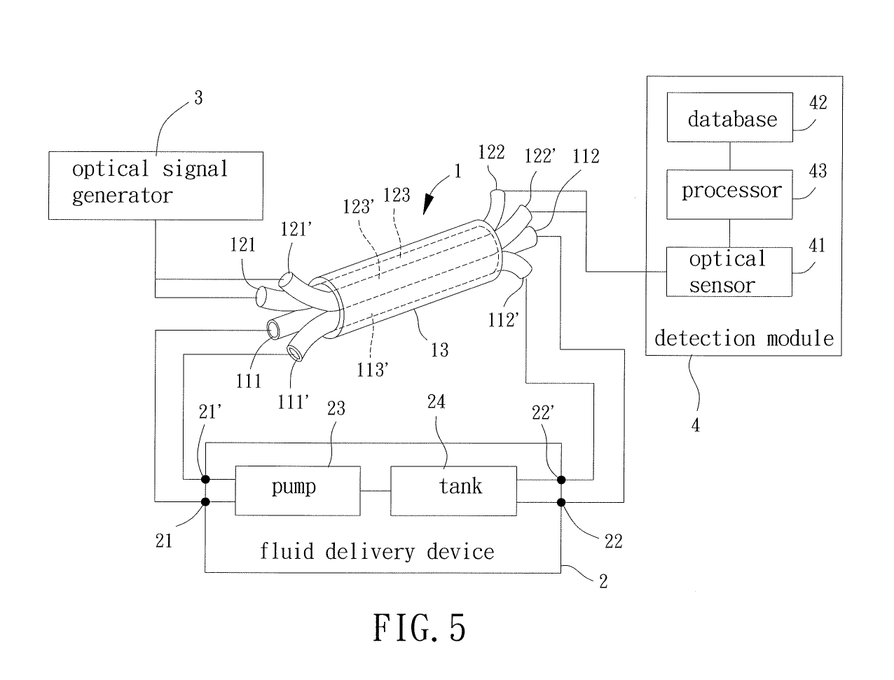

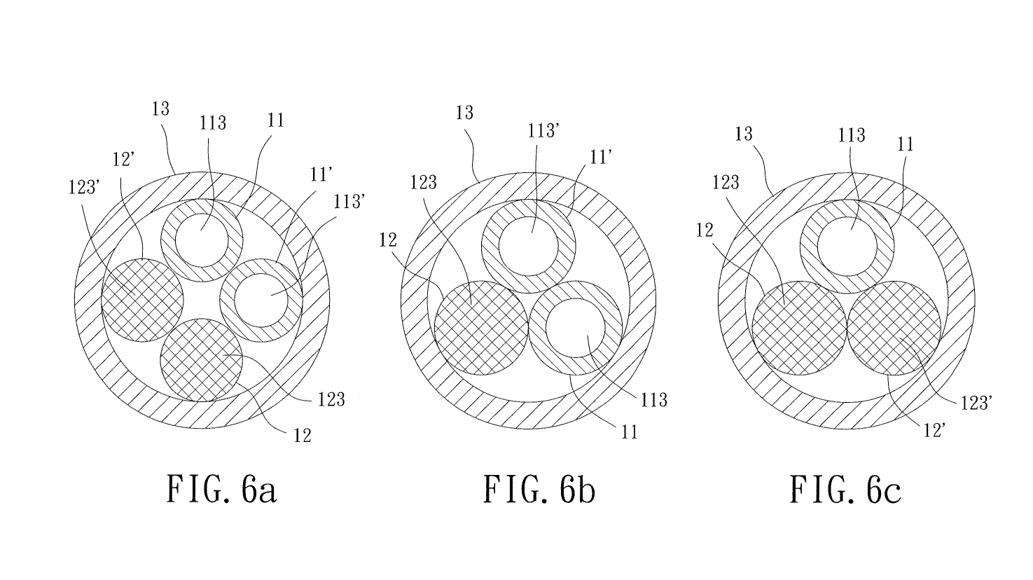

FIGS. 5 and 6a show a second embodiment according to the present invention. In this embodiment, the coupler 1 further includes an auxiliary hollow tube 11′ and an auxiliary optical fiber 12′. The auxiliary hollow tube 11′ includes a first auxiliary input end 111′ and a first auxiliary output end 112′. An auxiliary hollow passage 113′ is formed between the first auxiliary input end 111′ and the first auxiliary output end 112′. The auxiliary optical fiber 12′ includes a second auxiliary input end 121′ and a second auxiliary output end 122′. An auxiliary solid passage 123′ is formed between the second auxiliary input end 121′ and the second auxiliary output end 122′. The auxiliary hollow tube 11′, the auxiliary optical fiber 12′, the hollow tube 11, and the optical fiber 12 are enveloped in the jacket 13. A side of an outer periphery of the auxiliary hollow tube 11′ intimately abuts a side of the outer periphery of the optical fiber 12 or the auxiliary optical fiber 12′. A side of an outer periphery of the auxiliary optical fiber 12′ intimately abuts a side of the outer periphery of the hollow tube 11 or the auxiliary hollow tube 11′.

In the second embodiment, the fluid delivery device 2 further includes an auxiliary fluid output end 21′ and an auxiliary fluid recovery end 22′. The auxiliary fluid output end 21′ is connected to the first auxiliary input end 111′ of the auxiliary hollow tube 11′. The auxiliary fluid recovery end 22′ is connected to the first auxiliary output end 112′ of the auxiliary hollow tube 11′. The provision of the pump 23 and the tank 24 of the fluid delivery device 2 is not limited. The fluid delivery device 2 can include a plurality of pumps 23 and a plurality of tanks 24 to respectively form the fluid output end 21, the auxiliary fluid output end 21′, the fluid recovery end 22, and the auxiliary fluid recovery end 22′. Furthermore, the pumps 23 can be connected to the tanks 24 to smoothly deliver different fluids to be detected to a corresponding one of the hollow tube 11 and the auxiliary hollow tube 11′, which can be appreciated by a person having ordinary skill in the art.

In the second embodiment, in addition to connection with the second input end 121 of the optical fiber 12, the optical signal generator 3 is also connected to the second auxiliary input end 121′ of the auxiliary optical fiber 12′. The optical signal generator 3 can input an auxiliary optical signal to the second auxiliary input end 121′. In addition to connection with the second output end 122 of the optical fiber 12, the optical sensor 41 is also connected to the second auxiliary output end 122′ of the auxiliary optical fiber 12′ to sense the auxiliary optical signal outputted by the second auxiliary output end 122′ and to generate an auxiliary sensing datum.

In another example shown in FIG. 6b, the coupler 1 of the second embodiment only further includes the auxiliary hollow tube 11′. The auxiliary hollow tube 11′, the hollow tube 11, and the optical fiber 12 are enveloped in the jacket 13. A side of an outer periphery of the auxiliary hollow tube 11′ intimately abuts a side of the outer periphery of the optical fiber 12.

In a further example shown in FIG. 6c, the coupler 1 of the second embodiment only further includes the auxiliary optical fiber 12′. The auxiliary optical fiber 12′, the hollow tube 11, and the optical fiber 12 are enveloped in the jacket 13. A side of an outer periphery of the auxiliary optical fiber 12′ intimately abuts a side of the outer periphery of the hollow tube 11.

Specifically, in the example including the hollow tube 11, the optical fiber 12, and the auxiliary hollow tube 11′ (see FIG. 6b), since the fluid delivery device 2 can deliver to-be-detected fluids having different properties to the hollow tube 11 and the auxiliary hollow tube 11′ via the fluid output end 21 and the auxiliary fluid output end 21′, respectively, after the optical signal generator 3 inputs the optical signal to the optical fiber 12 while the side of the outer periphery of the auxiliary hollow tube 11′ intimately abutting the side of the outer periphery of the optical fiber 12, the optical sensor 41 obtains sensing data of the two fluids to be detected. Furthermore, the processor 43 compares the sensing data with the sample data to simultaneously detect two fluids having different properties, increasing the detection efficiency.

In the example including the hollow tube 11, the optical fiber 12, and the auxiliary optical fiber 12′ (see FIG. 6c), since the optical signal generator 3 can input the optical signal and the auxiliary optical signal through the optical fiber 12 and the auxiliary optical fiber 12′, respectively, and since the optical signal and the auxiliary optical signal preferably have different particular wavelength ranges (e.g., the particular wavelength range of the optical signal is 1200 nm-1700 nm, and the particular wavelength range of the auxiliary optical signal is 300 nm-700 nm), after the fluid delivery device 2 delivers the to-be-detected fluid to the hollow tube 11 while the side of the outer periphery of the auxiliary optical fiber 12′ intimately abutting the side of the outer periphery of the hollow tube 11, the optical sensor 41 obtains a sensing datum of the optical signal in the corresponding particular wavelength range and an auxiliary sensing datum of the auxiliary optical signal in the corresponding particular wavelength range. The processor 43 compares the sensing datum and the auxiliary sensing datum with the sample data to find the corresponding characteristic values in the particular wavelength ranges for detecting the fluids, increasing the detection accuracy.

Furthermore, in the example including the hollow tube 11, the optical fiber 12, the auxiliary hollow tube 11′, and the auxiliary optical fiber 12′ (see FIG. 6a), to-be-detected fluids having different properties and optical signals in different particular wavelength ranges can be transmitted to the coupler 1 and undergo the above operations to obtain the characteristic values in the particular wavelength ranges for the purpose of detecting different fluids, simultaneously increasing the detection efficiency and the detection accuracy. Likewise, the coupler 1 can include a plurality of auxiliary hollow tubes 11′ and a plurality of auxiliary optical fibers 12′ to simultaneously increase the detection efficiency and the detection accuracy through the above operations.

In the above embodiments, the hollow tube 11 and the optical fiber 12 have the same radius, and the experimental results shown in FIGS. 3, 4a, 4b, and 4c were obtained with the hollow tube 11 and the optical fiber 12 having the same radius.

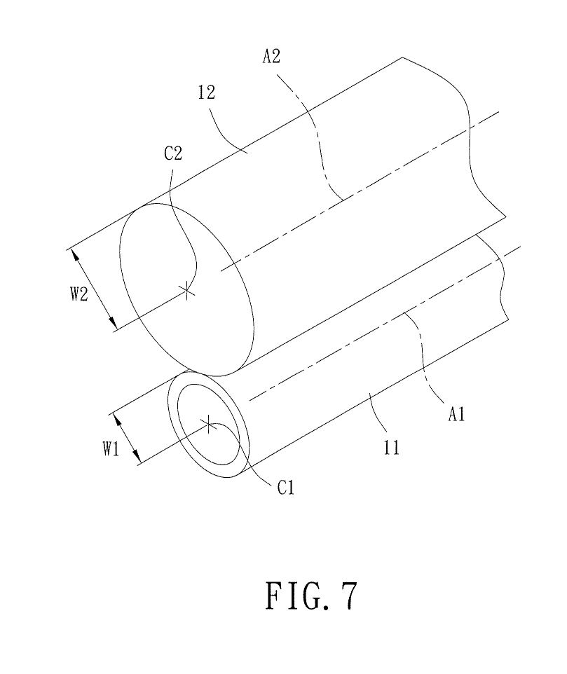

Nevertheless, the hollow tube 11 and the optical fiber 12 can have different radiuses. In the embodiment shown in FIG. 7, the hollow tube 11 has a radius W1 (see the spacing between a center C1 on an axis A1 of the hollow tube 11 and the outer periphery of the hollow tube 11). The optical fiber 12 has a radius W2 (see the spacing between a center C2 on an axis A2 of the optical fiber 12 and the outer periphery of the optical fiber 12). The coupling wavelength having the lowest energy under the coupling effect of the coupler 1 can be adjusted by making the radius W1 larger or smaller than the radius W2.

Since the coupling wavelength having the lowest energy under the coupling effect of the coupler 1 can be adjusted by making the radius W1 either larger or smaller than the radius W2, the following description is made by using the example in which the radius W1 is smaller than the radius W2. Specifically, when the coupler 1 has the coupling effect, the wavelength spectrum data can show the coupling wavelength having the lowest energy. Furthermore, the lowest energy generation location of the coupling wavelength (hereinafter referred to as “coupling point”) is related to the type and the temperature of the fluid to be detected. Furthermore, in the example of the coupler 1 including the hollow tube 11 and the optical fiber 12, the ratio of the radius W1 to the radius W2 also affects the generation location of the coupling point of the coupling wavelength in the wavelength section. Namely, ignoring the influence of other factors on the generation location of the coupling point in the wavelength section, the coupling point will be located in a wavelength section having a larger value (namely, a larger wavelength) when the radius W1 is equal to the radius W2, and the coupling point will be located in a wavelength section having a smaller value (namely, a smaller wavelength) when the radius W1 is smaller than the radius W2.

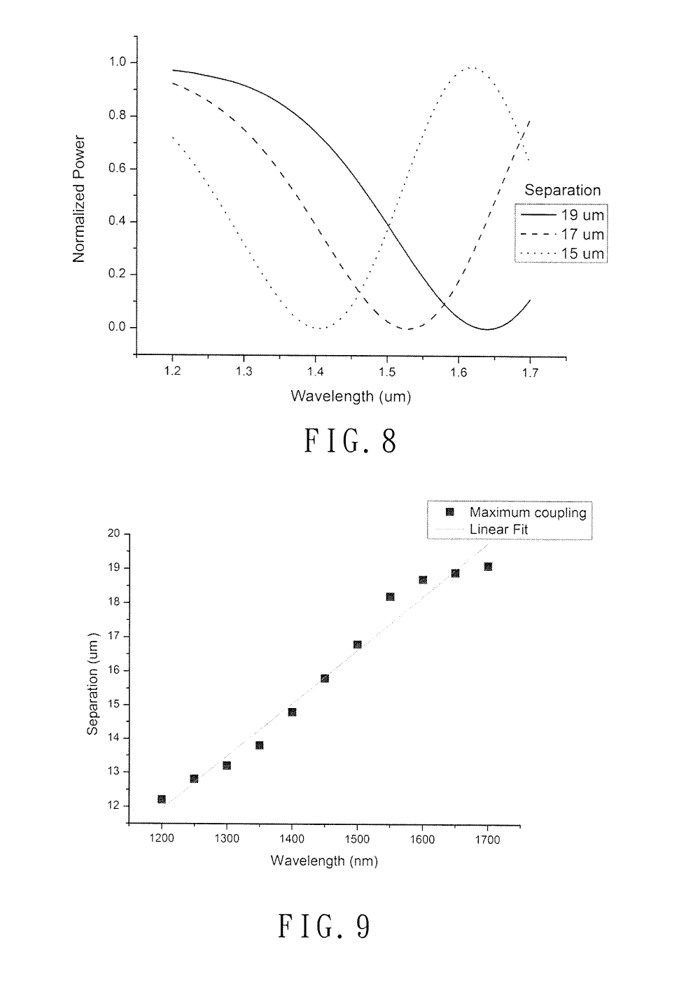

FIG. 8 is a diagram obtained by using ideal wavelength spectrum data simulated by experimental software under the condition that the radius W1 is smaller than the radius W2 and that the influence of other factors on the generation location of the coupling point in the wavelength section is ignored. The abscissa is the wavelength (the unit is nm), and the ordinate is the normalized power (the unit is dB). As can be seen from FIG. 8, when the separation between the axis A1 of the hollow tube 11 and the axis A2 of the optical fiber 12 is 19 μm (the radius W1 is 9 μm, and the radius W2 is 10 μm), a first coupling curve L1 is formed, and the wavelength of the coupling point of the first coupling curve L1 is about 1640 nm. When the separation between the axis A1 of the hollow tube 11 and the axis A2 of the optical fiber 12 is 17 μm (the radius W1 is 7 μm, and the radius W2 is 10 μm), a second coupling curve L2 is formed, and the wavelength of the coupling point of the second coupling curve L2 is about 1530 nm. When the separation between the axis A1 of the hollow tube 11 and the axis A2 of the optical fiber 12 is 15 μm (the radius W1 is 5 μm, and the radius W2 is 10 μm), a third coupling curve L3 is formed, and the wavelength of the coupling point of the third coupling curve L3 is about 1400 nm.

FIG. 9 shows the relationship between the separation between the axes A1 and A2 and the wavelength of the coupling point. The abscissa is the wavelength (the unit is nm), and the ordinate is the separation (the unit is μm). As can be seen from FIG. 9, when the separation between the axes A1 and A2 increases from 12 μm to 19 μm (the radius W1 is increased from 2 μm to 9 μm while the radius W2 is fixed at 10 μm), the wavelength of the coupling point is increased from 1200 nm to 1900 nm. As shown in FIGS. 8 and 9, given the fixed radius W2, when the radius W1 changes and is smaller than the radius W2, the wavelength of the coupling point is changed. When the radius W1 is 0.2-0.9 times the radius W2, the radius W1 and the wavelength of the coupling point have a linear relationship with each other. Namely, when the radius W2 is fixed, the wavelength of the coupling point is increased when the radius W1 is increased. Similarly, when the radius W2 is 0.2-0.9 times the radius W1, the radius W2 and the wavelength of the coupling point have a linear relationship with each other. Namely, when the radius W1 is fixed, the wavelength of the coupling point is increased when the radius W2 is increased.

Since the coupler 1 according to the present invention includes the hollow tube 11 and the optical fiber 12, given that the radius W2 of the optical fiber 12 is fixed, the wavelength of the coupling point can be controlled by making the radius W1 smaller than the radius W2. Similarly, given that the radius W1 of the hollow tube 11 is fixed, the wavelength of the coupling point can be controlled by making the radius W2 smaller than the radius W1. When the coupler 1 according to the present invention cooperates with the detection module 4 to proceed with fluid detection, if the detection module 4 can only proceed with detection of a particular wavelength section, the coupler 1 can adjust the ratio of the radius W1 to the radius W2 to control the wavelength of the coupling point to be in the particular wavelength section to which the detection module 4 is applicable. Thus, the coupler 1 can be used with detection modules 4 of different specifications, increasing the detection applicability.

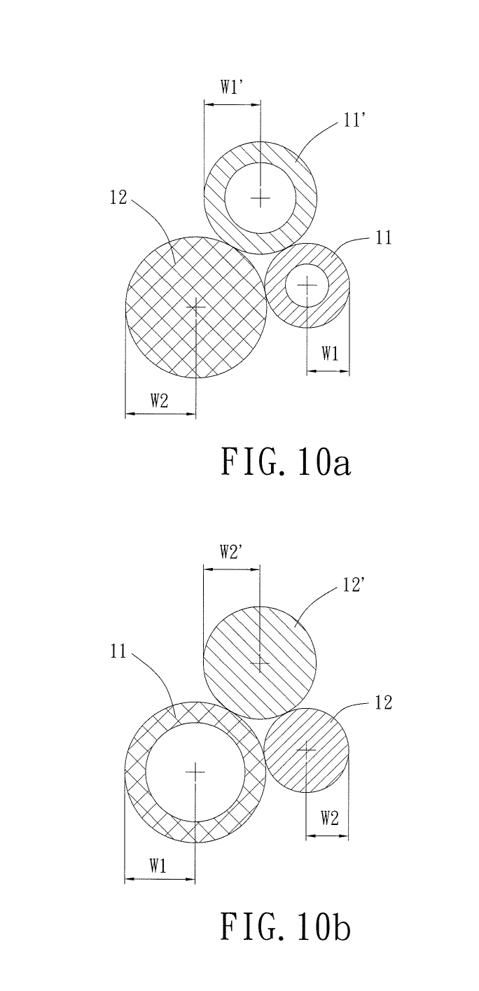

FIG. 10a shows an example of a coupler 1 including the hollow tube 11, the auxiliary hollow tube 11′, and the optical fiber 12. The auxiliary hollow tube 11′ has a radius W1′. The radius W1 of the hollow tube 11 and the radius W1′ of the auxiliary hollow tube 11′ are smaller than the radius W2 of the optical fiber 12. Furthermore, the radius W1 can be different from the radius W1′, and the radius W1′ can be 0.2-0.9 times the radius W2. By such an arrangement, when both of the hollow tube 11 and the auxiliary hollow tube 11′ are used to proceed with fluid detection, the hollow tube 11 and the auxiliary hollow tube 11′ can cooperate with a plurality of detection modules 4 of different specifications to proceed with detection. Thus, the coupler 1 is applicable to a plurality of detection modules 4 of different specifications, increasing the detection applicability and increasing the detection efficiency.

FIG. 10b shows another example of the coupler 1 including the hollow tube 11, the optical fiber 12, and the auxiliary optical fiber 12′. The auxiliary optical fiber 12′ has a radius W2′. The radius W2 of the optical fiber 12 and the radius W2′ of the auxiliary optical fiber 12′ are smaller than the radius W1 of the hollow tube 11. The radius W2 can be different from the radius W2′. Furthermore, the radius W2′ can be 0.2-0.9 times the radius W1. By such an arrangement, when both of the optical fiber 12 and the auxiliary optical fiber 12′ are used to proceed with fluid detection, the optical fiber 12 and the auxiliary optical fiber 12′ can cooperate with detection modules 4 of a plurality of different specifications to proceed with detection. Thus, the coupler 1 is applicable to a plurality of detection modules 4 of different specifications, increasing the detection applicability and increasing the detection efficiency.

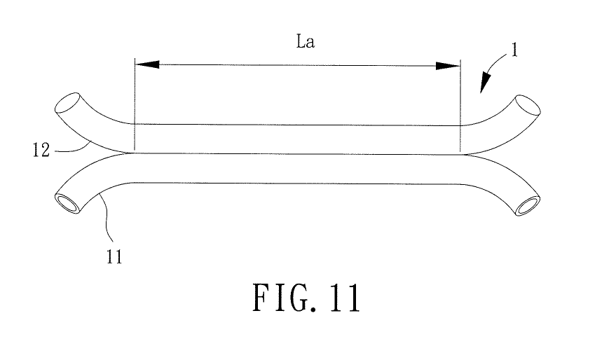

Furthermore, the coupling wavelength of the coupler according to the present invention can be adjusted by the following approach. With reference to FIG. 11, specifically, an abutting length La between the hollow tube 11 and the optical fiber 12 can be used as a first coupling section length. When the first coupling section length changes, the full width at half maximum of the coupling wavelength also changes. The full width at half maximum is the spacing between a middle point of a peak and a middle point of a valley of a waveform.

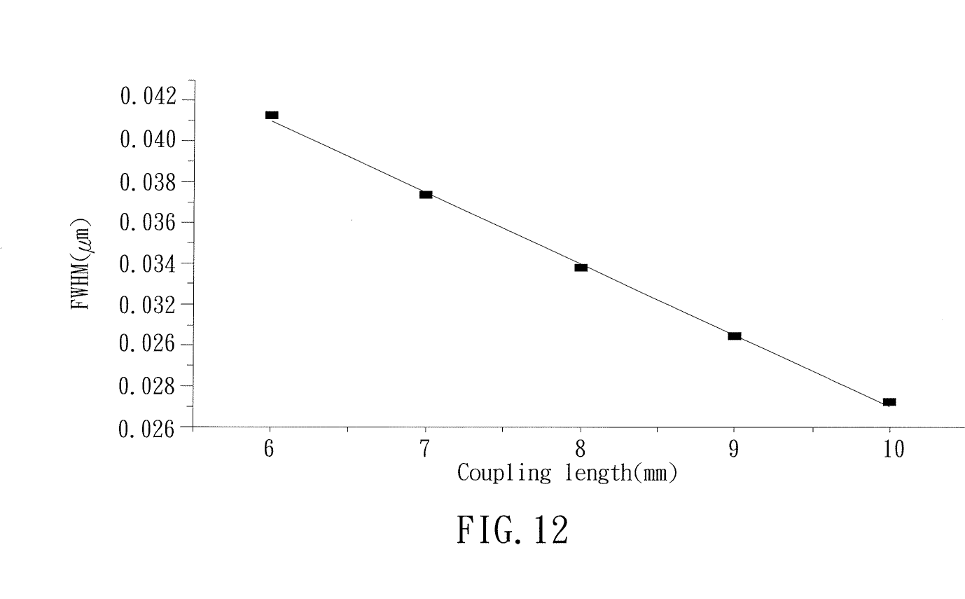

FIG. 12 is a diagram illustrating the relationship between the coupling section length and the fill width at half maximum of the coupling wavelength. The abscissa is the coupling section length (the unit is nm), and the ordinate is the full width at half maximum (the unit is nm). As can be seen from FIG. 12, the full width at half maximum decreases from 0.041 μm to 0.027 μm when the first coupling section length increases from 6 mm to 10 mm. Thus, in a case that the coupler 1 includes the hollow tube 11, the auxiliary hollow tube 11′, the optical fiber 12, and the auxiliary optical fiber 12′, the hollow tube 11 and the optical fiber 12 mutually abut with each other by the first coupling section length, the auxiliary hollow tube 11′ and the optical fiber 12 mutually abut with each other by a second coupling section length, the hollow tube 11 and the auxiliary optical fiber 12′ mutually abut with each other by a third coupling section length, and the auxiliary hollow tube 11′ and the auxiliary optical fiber 12′ mutually abut with each other by a fourth coupling section length. When the first, second, third, and fourth coupling section lengths are different from each other, a plurality of coupling wavelengths with different full widths at half maximum can be generated, and the coupler 1 is applicable to a plurality of detection modules 4 of different specifications, increasing the detection applicability and increasing the detection efficiency.

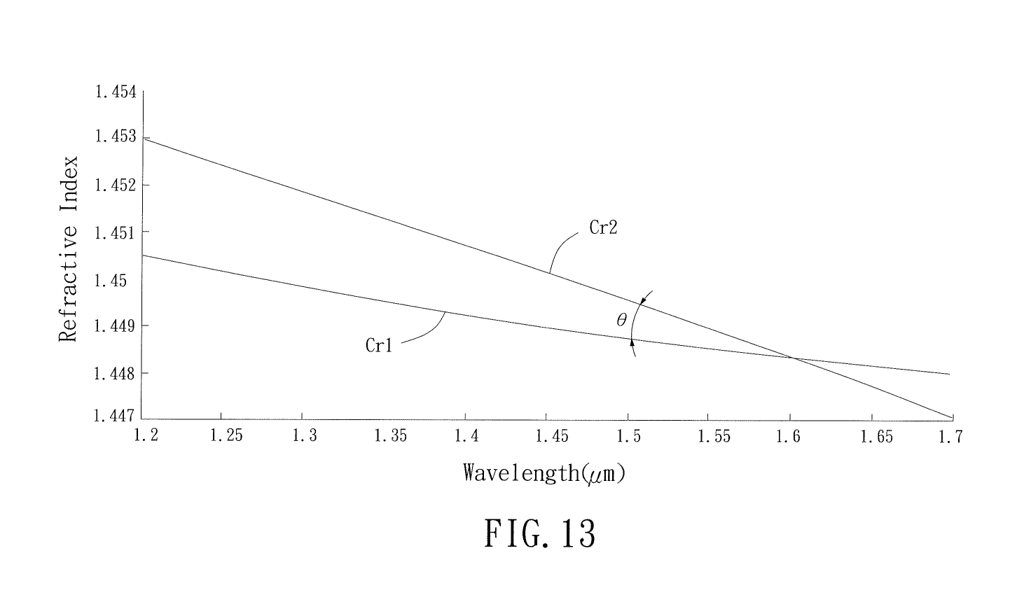

An ordinary optical fiber receiving the optical signal of different wavelengths will have different refractive indexes. FIG. 13 is a diagram illustrating the change in the refractive indexes of the hollow tube 11 and the optical fiber 12 according to the present invention under the optical signal of different wavelengths. The abscissa is the wavelength (the unit is μm), and the ordinate is the refractive index. As can be seen from FIG. 13, when the wavelength of the optical signal increases from 12 μm to 17 μm, the change of the refractive index of the hollow tube 11 is a curve Cr₁; namely, the curve Cr₁ represents the hollow tube refractive index change of the hollow tube 11. Likewise, the change of the refractive index of the optical fiber 12 is a curve Cr₂; namely, the curve Cr₂ represents the optical fiber refractive index change of the optical fiber 12. Since a difference exists between the hollow tube refractive index change and the optical fiber refractive index change, the curve Cr₁ and the curve Cr₂ will intersect with each other at a point (such as at the wavelength of 1.6 μm in FIG. 13) due to non-parallelism therebetween, and the curve Cr₁ and the curve Cr₂ have an angle θ therebetween in the refractive index change diagram.

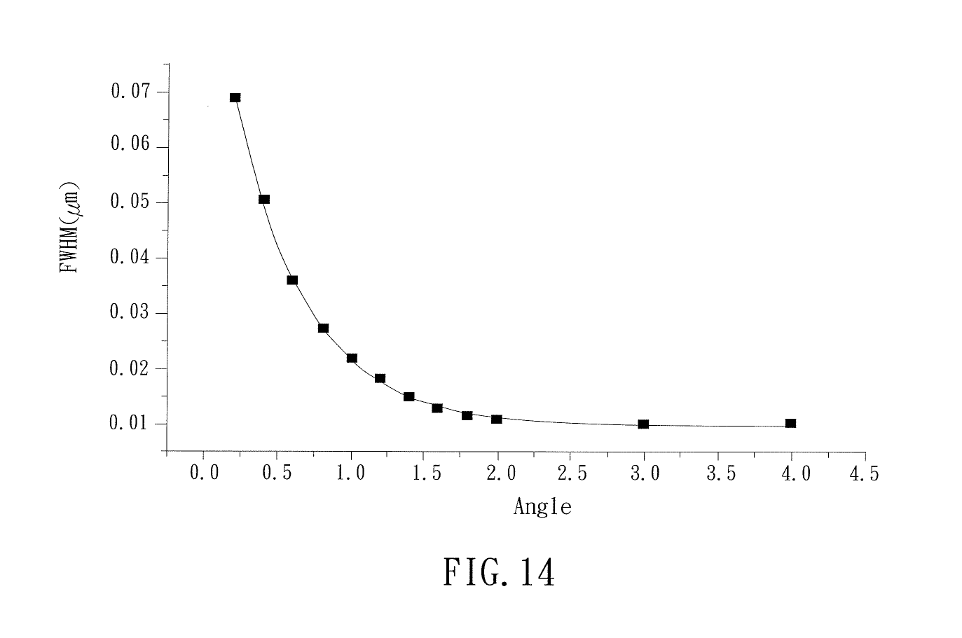

More specifically, when the angle θ between the curve Cr₁ and the curve Cr₂ changes (namely, there is a change the difference between the hollow tube refractive index change and the optical fiber refractive index change), the full width at half maximum of the coupling wavelength also changes. FIG. 14 is a diagram illustrating the relationship between the angle and the fill width at half maximum of the coupling wavelength. The abscissa is the angle, and the ordinate is the full width at half maximum (the unit is nm). As can be seen from FIG. 14, when the angle θ changes from 0.25° to 4° (namely, the difference between the hollow tube refractive index change and the optical fiber refractive index change increases), the full width at half maximum decreases from 0.07 μm to 0.01 μm at a rate similar to the exponential rate. Thus, in a case that the couple 1 including the hollow tube 11, the optical fiber 12, the auxiliary hollow tube 11′, and the auxiliary optical fiber 12′, the hollow tube 11 has the hollow tube refractive index change, the optical fiber 12 has the optical fiber refractive index change, the auxiliary hollow tube 11′ has an auxiliary hollow tube refractive index change, and the auxiliary optical fiber 12′ has an auxiliary optical fiber refractive index change. Furthermore, a first difference exists between the hollow tube refractive index change and the optical fiber refractive index change. A second difference exists between the auxiliary hollow tube refractive index change and the optical fiber refractive index change. A third difference exists between the hollow tube refractive index change and the auxiliary optical fiber refractive index change. A fourth difference exists between the auxiliary hollow tube refractive index change and the auxiliary optical fiber refractive index change. When the first, second, third, and fourth differences are different from one another, a plurality of coupling wavelengths with different full widths at half maximum can be generated. Furthermore, the coupler 1 is applicable to a plurality of detection modules 4 of different specification, increasing the detection applicability and increasing the detection efficiency.

In view of the foregoing, the fluid detector according to the present invention is applicable to different inspection items (such as different ingredient percentages or different temperatures) for fluid detection and increases the detection efficiency.

Furthermore, the coupler of the fluid detector according to the present invention is made of optical fiber cores, such that the influence of external magnetic waves on the coupler 1 can be isolated by the material characteristics of the coupler 1, increasing the detection accuracy.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A fluid detector comprising:
a coupler including a hollow tube, an optical fiber, and a jacket, with the hollow tube including a first input end and a first output end, with a hollow passage defined between the first input end and the first output end, with the optical fiber including a second input end and a second output end, with a solid passage defined between the second input end and the second output end, with the hollow tube and the optical fiber enveloped in the jacket, and with a side of an outer periphery of the hollow tube intimately abutting a side of an outer periphery of the optical fiber;
a fluid delivery device including a fluid output end and a fluid recovery end, with the fluid output end connected to the first input end of the hollow tube, and with the fluid recovery end connected to the first output end of the hollow tube;
an optical signal generator connected to the second input end of the optical fiber, with the optical signal generator adapted to input an optical signal to the second input end of the optical fiber; and
a detection module including an optical sensor, a database, and a processor, with the optical sensor connected to the second output end of the optical fiber, with the optical sensor detecting the optical signal outputted by the second output end and generating a sensing datum, with the database adapted to store a plurality of sample data, with the processor electrically connected to the optical sensor and the database, with the processor adapted to compare a characteristic value of the sensing datum with characteristic values of the plurality of sample data and adapted to generate a detection data;
with the coupler further including an auxiliary hollow tube, with the auxiliary hollow tube including a first auxiliary input end and a first auxiliary output end, with an auxiliary hollow passage formed between the first auxiliary input end and the first auxiliary output end with the auxiliary hollow tube, the hollow tube, and the optical fiber enveloped in the jacket, and with a side of an outer periphery of the auxiliary hollow tube intimately abutting another side of the outer periphery of the optical fiber;
with the coupler further including an auxiliary optical fiber, with the auxiliary optical fiber including a second auxiliary input end and a second auxiliary output end, with an auxiliary solid passage formed between the second auxiliary input end and the second auxiliary output end, with the auxiliary optical fiber, the hollow tube, and the optical fiber enveloped in the jacket, and with a side of an outer periphery of the auxiliary optical fiber intimately abutting another side of the outer periphery of the hollow tube;
with the hollow tube and the optical fiber mutually abutting with each other by a first coupling section length, with the auxiliary hollow tube and the optical fiber mutually abutting with each other by a second coupling section length, and with the first and second coupling section lengths being different from each other;
with the hollow tube and the auxiliary optical fiber mutually abutting with each other by a third coupling section length, and with the first and third coupling section lengths being different from each other;
with the hollow tube having a hollow tube refractive index change, with the auxiliary hollow tube having an auxiliary hollow tube refractive index change, with the optical fiber having an optical fiber refractive index change, with a first difference existing between the hollow tube refractive index change and the optical fiber refractive index change, with a second difference existing between the auxiliary hollow tube refractive index change and the optical fiber refractive index change, and with the first and second differences being different from each other;
with the auxiliary optical fiber having an auxiliary optical fiber refractive index change, with a third difference existing between the hollow tube refractive index change and the auxiliary optical fiber refractive index change, and with the first and third differences being different from each other.

2. The fluid detector as claimed in claim 1, wherein the sensing datum and the plurality of sample data include wavelength spectrum data containing energy change in a particular wavelength range.

3. The fluid detector as claimed in claim 2, wherein each of the characteristic value of the sensing datum and the characteristic values of the plurality of sample data is a coupling wavelength having lowest energy in the particular wavelength range.

4. The fluid detector as claimed in claim 1, with the fluid delivery device including a pump and a tank having a first end and a second end, with the tank adapted to store a fluid to be detected, with the pump including a first end forming the fluid output end and a second end connected to the first end of the tank, with the pump adapted to pump the fluid stored in the tank, and with the second end of the tank forming the fluid recovery end.

5. The fluid detector as claimed in claim 1, wherein the hollow tube, the optical fiber, and the jacket are made of a same material.

6. (canceled)

7. The fluid detector as claimed in claim 1, with the fluid delivery device further including an auxiliary fluid output end and an auxiliary fluid recovery end, with the auxiliary fluid output end connected to the first auxiliary input end of the auxiliary hollow tube, and with the auxiliary fluid recovery end connected to the first auxiliary output end of the auxiliary hollow tube.

8. (canceled)

9. The fluid detector as claimed in claim 1, with the auxiliary optical fiber, the auxiliary hollow tube, the hollow tube, and the optical fiber enveloped in the jacket.

10. The fluid detector as claimed in claim 1, with the optical signal generator connected to the second auxiliary input end of the auxiliary optical fiber, with the optical signal generator adapted to input an auxiliary optical signal towards the second auxiliary input end, with the optical sensor connected to the second auxiliary output end of the auxiliary optical fiber, and with the optical sensor adapted to sense the auxiliary optical signal outputted by the second auxiliary output end and adapted to generate an auxiliary sensing datum.

11. The fluid detector as claimed in claim 1, wherein the hollow tube has a radius different from a radius of the optical fiber.

12. The fluid detector as claimed in claim 1, wherein the hollow tube has a radius different from a radius of the optical fiber, and wherein the auxiliary hollow tube has a radius different from the radius of the optical fiber.

13. The fluid detector as claimed in claim 12, wherein the radius of the auxiliary hollow tube is different from the radius of the hollow tube.

14. The fluid detector as claimed in claim 1, wherein the optical fiber has a radius different from a radius of the hollow tube, and wherein the auxiliary optical fiber has a radius different from the radius of the hollow tube.

15. The fluid detector as claimed in claim 14, wherein the radius of the auxiliary optical fiber is different from the radius of the optical fiber.

16. (canceled)

17. (canceled)

18. The fluid detector as claimed in claim 9, with the auxiliary hollow tube and the auxiliary optical fiber mutually abutting with each other by a fourth coupling section length, and with the first, second, third, and fourth coupling section lengths being different from one another.

19. (canceled)

20. (canceled)

21. The fluid detector as claimed in claim 9, with a fourth difference existing between the auxiliary hollow tube refractive index change and the auxiliary optical fiber refractive index change and with the first, second, third, and fourth differences being different from one another.

22. A coupler comprising:
a hollow tube including a first input end and a first output end, with a hollow passage defined between the first input end and the first output end;
an optical fiber including a second input end and a second output end, with a solid passage defined between the second input end and the second output end; and
a jacket, with the hollow tube and the optical fiber enveloped in the jacket, and with a side of an outer periphery of the hollow tube intimately abutting a side of an outer periphery of the optical fiber;
with the coupler further including an auxiliary hollow tube, with the auxiliary hollow tube including a first auxiliary input end and a first auxiliary output end, with an auxiliary hollow passage formed between the first auxiliary input end and the first auxiliary output end, with the auxiliary hollow tube, the hollow tube, and the optical fiber enveloped in the jacket, and with a side of an outer periphery of the auxiliary hollow tube intimately abutting another side of the outer periphery of the optical fiber;
with the coupler further including an auxiliary optical fiber, with the auxiliary optical fiber including a second auxiliary input end and a second auxiliary output end, with an auxiliary solid passage formed between the second auxiliary input end and the second auxiliary output end, with the auxiliary optical fiber, the hollow tube, and the optical fiber enveloped in the jacket, and with a side of an outer periphery of the auxiliary optical fiber intimately abutting another side of the outer periphery of the hollow tube;
with the hollow tube and the optical fiber mutually abutting with each other by a first coupling section length, with the auxiliary hollow tube and the optical fiber mutually abutting with each other by a second coupling section length, and with the first and second coupling section lengths being different from each other;
with the hollow tube and the auxiliary optical fiber mutually abutting with each other by a third coupling section length, and with the first and third coupling section lengths being different from each other;
with the hollow tube having a hollow tube refractive index change, with the auxiliary hollow tube having an auxiliary hollow tube refractive index change, with the optical fiber having an optical fiber refractive index change, with a first difference existing between the hollow tube refractive index change and the optical fiber refractive index change, with a second difference existing between the auxiliary hollow tube refractive index change and the optical fiber refractive index change, and with the first and second differences being different from each other;
with the auxiliary optical fiber having an auxiliary optical fiber refractive index change, with a third difference existing between the hollow tube refractive index change and the auxiliary optical fiber refractive index change, and with the first and third differences being different from each other.

23. The coupler as claimed in claim 22, wherein the hollow tube, the optical fiber, and the jacket are made of a same material.

24. (canceled)

25. (canceled)

26. The coupler as claimed in claim 22, with the auxiliary optical fiber, the auxiliary hollow tube, the hollow tube, and the optical fiber enveloped in the jacket.

27. The coupler as claimed in claim 22, wherein the hollow tube has a radius different from a radius of the optical fiber.

28. The coupler as claimed in claim 22, wherein the hollow tube has a radius different from a radius of the optical fiber, and wherein the auxiliary hollow tube has a radius different from the radius of the optical fiber.

29. The coupler as claimed in claim 28, wherein the radius of the auxiliary hollow tube is different from the radius of the hollow tube.

30. The coupler as claimed in claim 22, wherein the optical fiber has a radius different from a radius of the hollow tube, and wherein the auxiliary optical fiber has a radius different from the radius of the hollow tube.

31. The coupler as claimed in claim 30, wherein the radius of the auxiliary optical fiber is different from the radius of the optical fiber.

32. (canceled)

33. (canceled)

34. The coupler as claimed in claim 26, with the auxiliary hollow tube and the auxiliary optical fiber mutually abutting with each other by a fourth coupling section length, and with the first, second, third, and fourth coupling section lengths being different from one another.

35. (canceled)

36. (canceled)

37. The coupler as claimed in claim 26, with a fourth difference existing between the auxiliary hollow tube refractive index change and the auxiliary optical fiber refractive index change and with the first, second, third, and fourth differences being different from one another.
